(19) United States
(12) Patent Application Publication
(10) Pub. No.: US 2011/0216207 A1
(43) Pub. Date: Sep. 8, 2011

(54) DISPLAY CONTROL APPARATUS, METHOD THEREOF AND STORAGE MEDIUM

(75) Inventor: Kikuo Kazama, Kawasaki-shi (JP)

(73) Assignee: CANON KABUSHIKI KAISHA, Tokyo (JP)

(21) Appl. No.: 13/028,350

(22) Filed: Feb. 16, 2011

(30) Foreign Application Priority Data
Mar. 4, 2010 (JP) 2010-048256

(51) Int. Cl. H04N 5/225

(52) U.S. Cl. 348/207.1

(57) ABSTRACT

A display control unit for displaying an image on a display screen displays a viewing video image on the display screen which a user observes. A control unit switches the image displayed on the display screen from the view video image to an image for capturing, prepared by an image sensing apparatus, corresponding to receiving a capturing preparation signal from the image sensing apparatus via a communication unit.

### BACKGROUND OF THE INVENTION

1. Field of the Invention

The present invention relates to a display control apparatus, method thereof and storage medium which change image-display control using a control signal from an external apparatus.

2. Description of the Related Art

There have been various proposed methods of arranging an image obtained by an image sensing apparatus at a desired position on a large display such as a projector, an LCD and a plasma display, electronic paper and so on.

For example, an apparatus proposed in Japanese Patent Laid-Open No. 2001-325069 (hereafter Ref. 1) determines a coordinate at which a beam points by capturing a plurality of marks displayed on a predetermined position and a beam point irradiated from the apparatus itself. The apparatus described in Ref. 1 captures the plurality of the marks displayed at the predetermined position on a predetermined plane and the point of the irradiated beam, and then determines a position which the beam indicated by extracting both points of the mark and beam from the obtained image.

Further, on a personal computer, it is generally performed to freely lay out an image such as a photograph or an illustration on a background sheet using some software to edit the images. In graphical user interface (GUI), it is possible to operate by directly designating graphic forms on a display screen using pointing tools such as a mouse and a pen-input device when arranging graphic forms that include an image.

In Japanese Patent Laid-Open No. 07-121293 (hereafter Ref. 2), not using tools such as a mouse and a pen-input but instead using an image sensing apparatus to realize the operation of pointing is proposed. According to this proposal, a marker is inserted into a display screen at every constant frame interval, and only maker images are extracted by differential image processing using the adjacent frame and a position is determined by detecting a designated position based on the marker image.

However, in the pointing methods of the above prior art, it is necessary to always display a marker image on the screen (Ref. 1) or to alternately display a marker image and a normal screen image (Ref. 2). A marker image is not an object which a user desires to observe but to be utilized for calculating the pointed position. Therefore, such screen that a marker is displayed would give the user an uncomfortable feeling. Moreover, the space on which the marker is displayed cannot be used for normal screen images. By contrast, the space for displaying the marker can be used for normal screen images when alternately displaying a marker image and a normal screen image (without a marker). However, the user may see flickering on the screen when the user observes the normal screen image.

More recently, advertising information giving a user clear legibility and a code image (for example, QR code) indicating the related URL are often displayed on a screen. However, the space for the QR code would be useless and wasted in order to insert visual information because the QR code is not recognizable even if the user sees it.

### SUMMARY OF THE INVENTION

In order to solve the above problems, one of the embodiments of the present invention provides a display control apparatus and a control method thereof, that enables switching between a normal image display and an image display for capture at an appropriate timing and reduces a user's sense of discomfort.

According to one aspect of the present invention, there is provided a display control apparatus for displaying an image on a display screen of a display unit, comprising: the display unit configured to display a video image on the display screen which a user observes; a communication unit configured to communicate with an image sensing apparatus, to which communicably connected; and a control unit configured to switch the image displayed on the display screen from the video image to an image for capturing, prepared by the image sensing apparatus, in response to a reception of a capturing preparation signal form the image sensing apparatus via the communication unit.

Also, according to another aspect of the present invention, there is provided a method for controlling a display control unit which displays an image on a display screen of a display unit, comprising steps of: displaying a video image on the display screen which a user observes; and switching the image displayed on the display screen from the video image to an image for capturing, prepared by the image sensing apparatus, corresponding to a reception of a capturing preparation signal from the image sensing apparatus via the communication unit.

Further, features of the present invention will become apparent from the following description of exemplary embodiments with reference to the attached drawings.

### BRIEF DESCRIPTION OF THE DRAWINGS

FIG. 1 shows an exemplary configuration for a display system.

FIG. 2A is a block diagram for showing an example of an image sensing apparatus.

FIG. 2B is a block diagram for showing an example of a personal computer.

FIG. 3 is a flowchart showing the process of obtaining a marker displayed on a display unit by the image sensing apparatus.

FIG. 4 is a flowchart showing the process of detecting a coordinate of the region captured by the image sensing apparatus.

FIG. 5 is a flowchart showing the process of detecting a coordinate of the region captured by the image sensing apparatus.

FIG. 6 is a drawing showing the flow process from capture of a marker image to detection of a coordinate on the display unit.

FIGS. 7A and 7B are drawings showing the process of emphatically displaying images existing within the calculated coordinates.

FIGS. 8A to 8C are drawings showing the process of moving the display of selected images.

FIGS. 9A and 9B are drawings showing the process of deleting the display of selected images.

FIG. 10 is a drawing showing the process of lengthening the marker's display intervals on the display unit.

FIG. 11 is a drawing showing the process of shortening the marker's display intervals on the display unit.

FIG. 12 is a drawing showing the process of lengthening the marker's display intervals and shortening the marker's display intervals on the display unit.

### DESCRIPTION OF THE EMBODIMENTS

As discussed in detail below, referring to attached drawings, several embodiments in the present invention are explained.

### First Embodiment

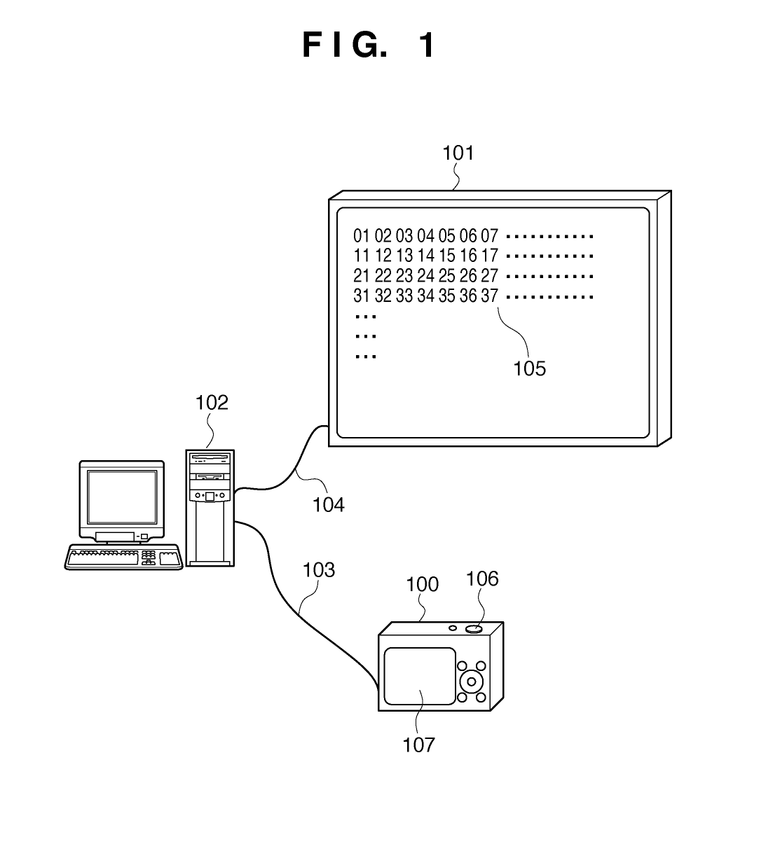

First of all, an image sensing apparatus, a display unit and a control unit regarding the embodiments of the present invention are explained. FIG. 1 is a drawing showing an example of the structure of the display system regarding the embodiments. In this display system, the image sensing apparatus is used as an input means in order to designate a desired position on a screen of the display unit 101. In this embodiment, a digital camera 100 is used as the image sensing apparatus. The display unit 101 displays video images on its display screen under the control of a personal computer 102. For example, a screen of a projector, a LCD, a plasma display and others are used as the display unit 101.

Various information processing units are available for a display control apparatus which controls how to display for the display unit 101, and in this embodiment, the personal computer 102 is used. By performing the installed (application) programs, the personal computer 102 implements display control for the display unit 101 and various kinds of processing including each process shown in flowcharts, described later. The digital camera 100 and the personal computer 102 are communicably connected with a data signal connection 103. For example, wired connections using USB or RS-232C, or wireless connections using Bluetooth or Wireless LAN can be used for the data signal connection 103. The display unit 101 and the personal computer 102 are connected with a wired cable or wireless scheme of the Wireless LAN in order to transfer video signals such as analog RGB or DVI as shown by a video signal connection 104.

Further, a marker image 105 is displayed on the display unit 101 under control of the personal computer 102. When an operator pushes a release switch 106, the marker image 105 displayed on the display unit 101 is captured by the digital camera 100, and then the captured image is transferred to the personal computer 102 via the data signal connection 103. In this embodiment, although the marker image 105 is indicated with only numbers or characters, it may be indicated with any code, number, character or geometrical pattern. In this regard, however, the indications should be unique at their coordinates and their coordinate should be easily detected by the local image.

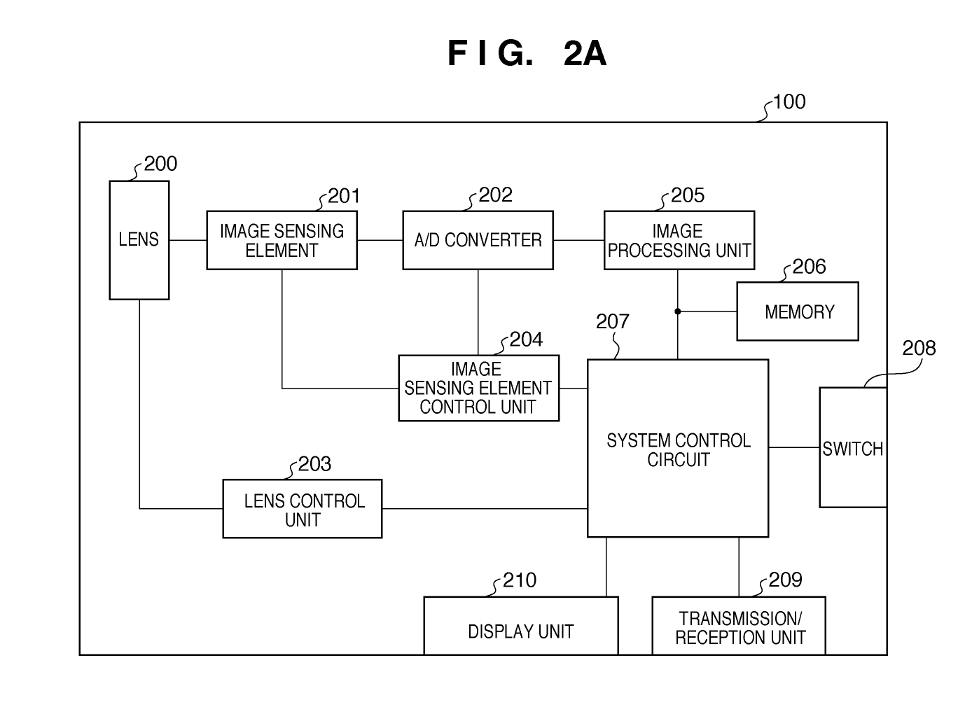

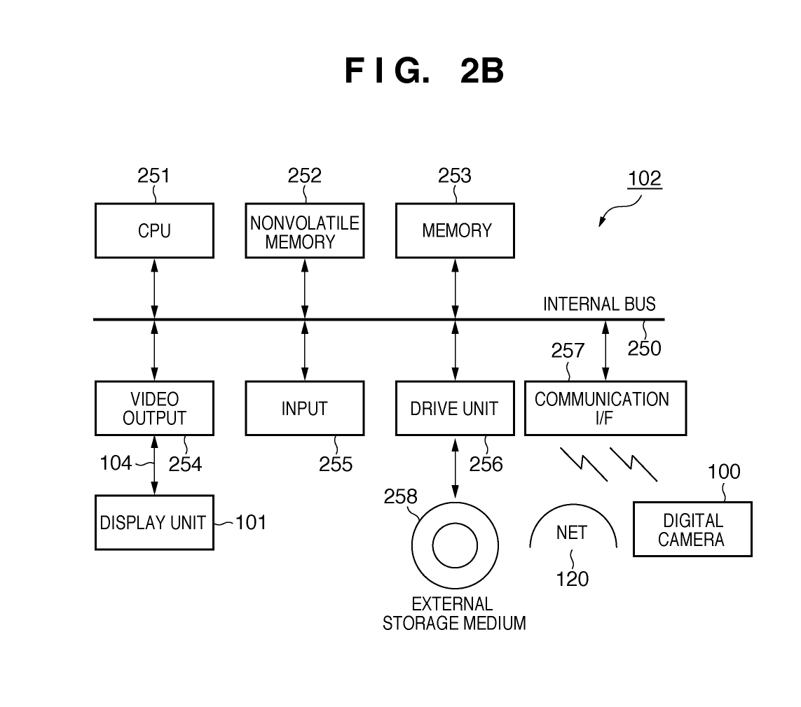

FIG. 2A shows a block diagram of the digital camera 100 as the image sensing apparatus. An image sensing element 201 converts an optical image formed through a shooting lens 200 to an electrical signal. An A/D converter 202 converts an analog signal output from the image sensing element 201 to a digital signal. A lens control unit 203 controls focusing and zooming of the shooting lens 200. An image sensing element control unit 204 provides a control signal for the image sensing element 201 and the A/D converter 202 under control of a system control circuit 207. An image processing unit 205 performs predetermined pixel interpolating processing and color converting processing for data from the A/D converter 202 or for image data from the system control circuit 207. The memory 206 stores a captured image and has enough capacity to store a predetermined number of still images and a predetermined period of moving images. Further, the memory 206 can be used for a work space of the image processing unit 205 or the system control circuit 207. The system control circuit 207 provides control for the whole digital camera 100. The system control circuit 207 includes a memory (not shown) to store constants, parameters, programs and others for operations. A switch 208 indicates a general switch which is attached with the digital camera 100, for example, the following items are included: a power switch to control power ON/OFF, a mode dial switch for switching modes (normal image sensing mode, image selecting mode, reproducing mode and so on) of the image sensing apparatus, a zoom switch for zooming by driving the shooting lens 200, a shutter switch for shooting and others. A transmission/reception unit 209 comprises a connector for connection and control unit for communication with a wired cable using USB or RS-232C, and a transmitter and a control unit for wireless communication using Wireless LAN. The transmission/reception unit 209 can transmit a captured image stored in the memory 206 to a communication partner and receive information indicating operating status of the communication partner and transfer it to the system control circuit 207. A display unit 210 comprises a display such as a liquid crystal panel 107 and a backlight which irradiates light from the back face of the liquid crystal panel 107.

FIG. 2B is a block diagram for the personal computer 102 as a display control unit. As shown in FIG. 2B, an internal bus 250 is connected with CPU 251, a nonvolatile memory 252, a memory 253, a video output 254, an input 255, a drive unit 256 and a communication I/F 257. Each of these units connected with the internal bus 250 is configured to communicate with one another via the internal bus 250. The nonvolatile memory 252 stores images, other data and several kinds of programs enabling the operation of the CPU 251. For example, the memory 253 comprises a RAM, which can be utilized as a work memory of the CPU 251. For example, the CPU 251 controls each function of the personal computer 102 using the memory 253 as a work memory in accordance with a program stored in the nonvolatile memory 252.

The input 255 receives an operation instruction by the user and generates a control signal corresponding to the received operation instruction and then transfers the control signal to the CPU 251. For example, for an input device receiving an operation instruction by the user, the input 255 comprises an input device for inputting character information such as a keyboard, or a pointing device such as a mouse or a touch panel. Further, the touch panel is an input device used to output coordinate information corresponding to a touched position of an input portion, for example, configured in a plane. The CPU 251 controls each function of the personal computer 102 in accordance with a program based on a control signal that is generated and provided by the input 255 corresponding to the operation instruction by the user using the input device. In this way, the operation of the personal computer 102 corresponding to the desired operation by the user can be implemented.

The video output 254 outputs a display signal in order to display a video image on a display means such as the display unit 101. For example, a display control signal generated by the CPU 251 in accordance with the program and the video signal generated based on the display control signal are provided to the video output 254. Then the video output 254 outputs the video signal based on the display control signal to the display unit 101. For example, the video output 254 provides a GUI (Graphical User Interface) screen in order to display it on the display unit 101, which arranges GUI based on the display control signal generated by the CPU 251. Further, the video output 254 provides a normal viewing video image and marker image 105 in order to display them on the display unit 101, which will be described later, based on the control signal generated by the CPU 251.

The display unit 101 may be a display configured as part of the personal computer 102, or be an external display means. As previously described, it can be a screen of a projector, a LCD, a plasma display and others. As previously indicated, the display unit 101 is connected to the video output 254 of the personal computer 102 via the video signal connection 104.

The drive unit 256 is configured to mount an external storage medium 258 such as CD or DVD, and read out data from the external storage medium 258 and write data into the external storage medium 258 in accordance with the control of the CPU 251. In addition, the drive unit 256 configured to mount the external storage medium 258 is not limited to CD or DVD. For example, the drive unit 256 may be configured to mount a nonvolatile semi-conductor memory such as a memory card. The communication interface I/O 257 provides (wired or wireless) communication with network 120 such as LAN or Internet and the digital camera 100 (more precisely, the transmission/reception unit 209) based on the control of the CPU 251. Transmissions of a push-down completion signal (a capturing preparation signal), captured images, a reception of notice for interruption during obtaining a coordinate, a display completion signal to the digital camera 100, and success or failure information of obtaining a coordinate, which are described later, are also performed via the communication interface I/O 257.

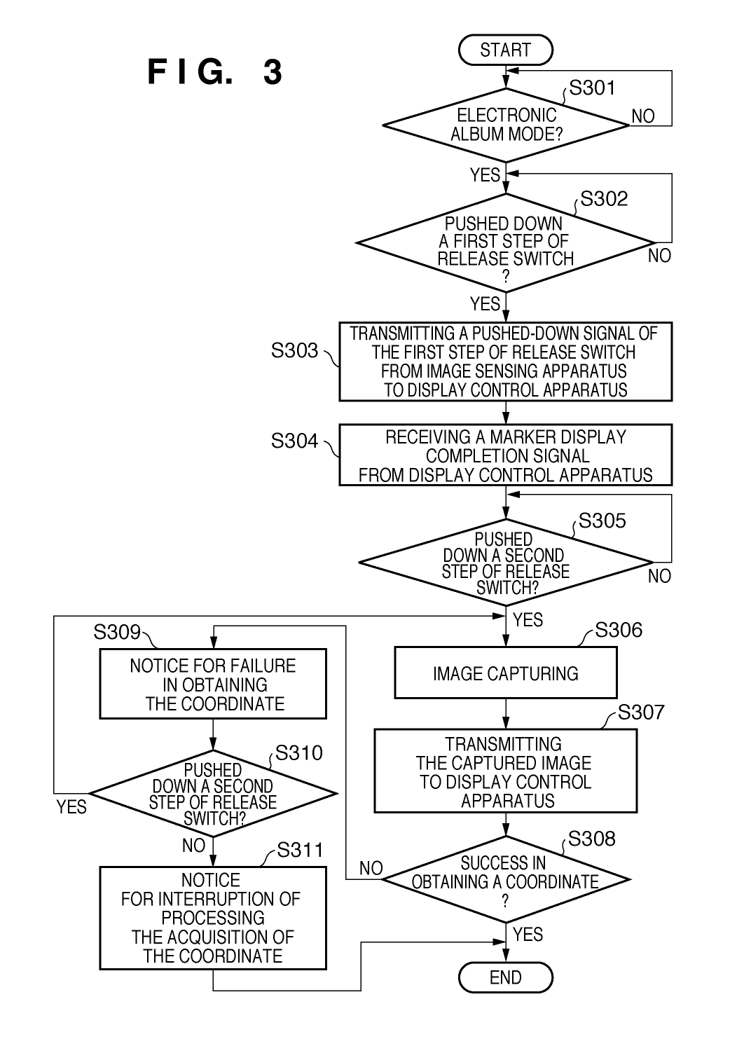

Next, operations regarding the digital camera 100 are explained referring to a flowchart as shown in FIG. 3. Each step in the flowchart of FIG. 3 is performed by the system control circuit 207, which extends a program stored in the memory (not shown in the figure) contained in the digital camera 100 to the memory 206, and implements the program. First, at step S301, the system control circuit 207 in the digital camera 100 checks whether or not the control proceeds to an appropriate mode for obtaining a marker. In this embodiment, the digital camera 100 has an “electrical album” mode. When the digital camera 100 captures the marker image 105 displayed on the display unit 101 after proceeding to the electrical album mode, a predetermined process is applied to the marker image and then it is possible to detect a region on the display unit 101 which the digital camera 100 has captured.

Next, at step S302, the system control circuit 207 detects whether or not a first step of the release switch 106 has been pushed down. As shown in FIG. 1, the release switch 106 is a switch for starting an imaging operation of the digital camera 100. In this embodiment, the release switch 106 has two steps: the first step switch becomes ON when the photographer lightly pushes the button down, and the second step switch becomes ON when it is strongly pushed down even more. Generally speaking, an imaging preparation, such as an auto-focusing operation, is started in the digital camera 100 when the first step switch is ON. Then, the image capture begins when the second step switch is ON.

If the system control circuit 207 detects that the first step of the release switch 106 is pushed down at step S302, then the control proceeds to step S303. At step S303, the system control circuit 207 transmits the push-down completion signal at the first step of the release switch 106, as the capturing preparation signal to the personal computer 102 uses the transmission/reception unit 209. In this case, the capturing preparation signal corresponds to the start of the auto-focusing. After the personal computer 102 receives the push-down completion signal at the push-down of the first step, it starts to alternately display the marker image 105 and the normal viewing video image on the display unit 101 and transmits a marker display completion signal to the digital camera 100. The operational flows of the personal computer 102 as a display control apparatus will be described later in detail.

At step S304, if the marker display completion signal is received from the personal computer 102 via the transmission/reception unit 209, the control proceeds to step S305. At this step, after the second step of the release switch 106 is pushed down, the control proceeds to step S306, and the system control circuit 207 performs the image capture with the image sensing element 201. Thus, it is assumed that the display screen of the display unit 101 is captured while the marker image 105 and the normal viewing video image is alternately displayed on the display screen under the control of the personal computer 102. After the completion of capturing, at step S307, the system control circuit 207 transmits the captured image to the personal computer 102 via the transmission/reception unit 209. The personal computer 102 obtains a coordinate based on the marker image 105 included in the captured image which is then transmitted from the digital camera 100.

Next, the control proceeds to step S308, and the system control circuit 207 obtains the success or failure information by obtaining the coordinate from the personal computer 102 via the transmission/reception unit 209. Upon receiving the failure information of obtaining the coordinate from the personal computer 102, the control proceeds to step S309. Upon receiving the success information of obtaining the coordinate from the personal computer 102, the sequence of the flowchart ends.

Once receiving the failure information of obtaining the coordinates and the control proceeds to step S309, the system control circuit 207 then sends the photographer a message by displaying the notice of the failure of obtaining the coordinate on the liquid crystal panel 107 of the digital camera 100. Next, at step S310, the system control circuit 207 detects again whether or not the second step of the release switch 106 has been pushed down. If the second step of the release switch 106 is pushed down, then the control proceeds to step S306 and the system control circuit 207 performs the image capture for obtaining a coordinate again. If the second step of the release switch 106 is not pushed down, then the system control circuit 207 determines that the operation of obtaining the coordinate of the marker image 105 is interrupted at step S311. Then it sends the photographer a message by displaying the interruption of obtaining the coordinate on the liquid crystal panel 107. This way, the images are continuously captured as long as the second switch of the release switch 106 is kept pushed down, and the continuously captured images are sequentially sent until the success information of obtaining the coordinate is received. In addition, at step S307, the number of the transmitted images may be one or more than one. If the number of the transmitted image is one, the system control circuit 207 will be configured to wait for the success or failure information of obtaining the coordinate after transmitting the captured image to the display control apparatus every time when one image is captured. If the number of the transmitted image is more than one, the system control circuit 207 will be configured to wait for the success or failure information of obtaining the coordinate after transmitting a plurality of captured images to the display control apparatus after a certain number of images are stored. Moreover, the system control circuit 207 can be configured to continuously capture the image and transmit the captured images to the display control apparatus until the success information of obtaining the coordinate has been received, regardless of being a success or failure. In this way, even if the communication such as radio transmission is randomly interrupted, the coordinate can still be obtained.

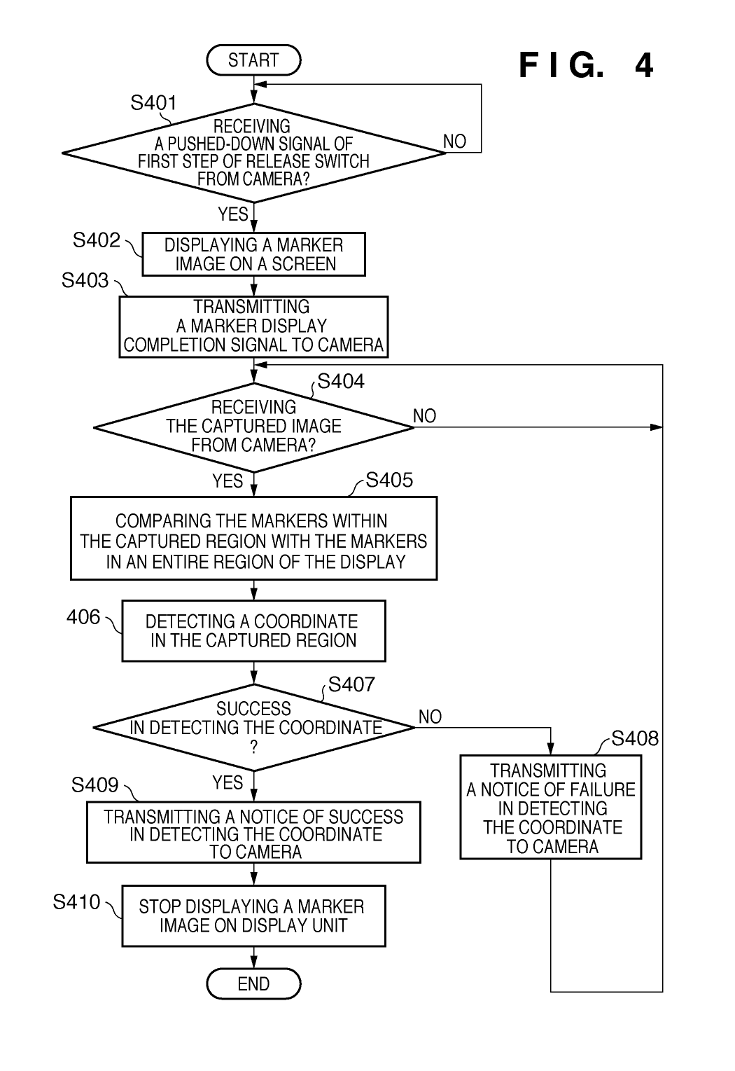

Next, the operations of the personal computer as a display control apparatus related to this embodiment are explained in accordance with a flowchart. FIG. 4 is the flowchart showing the process of the display control apparatus (personal computer 102) detecting a coordinate of the region which an imaging sensing apparatus (digital camera 100) of this embodiment captures. Meanwhile, it is assumed that the personal computer displays video images for the user's observation on a screen of the display unit 101. Further, CPU 251 of the personal computer 102 performs the process of operations as shown in FIG. 4 by extending a program stored in the nonvolatile memory 252 to the memory 253 and implementing it.

At step S401, the control proceeds to step S402 after receiving a push-down completion signal (a capturing preparation signal) from the digital camera 100 indicating that the first step of the release switch 106 has been pushed down. At step S402, the personal computer 102 starts to display the marker image 105 by the display unit 101, corresponding to a display apparatus. The marker image 105 is a video image for capturing, which has been prepared for the purpose of being captured by the digital camera 100. In this configuration, the personal computer 102 alternately switches from the status of displaying a normal viewing video image on the display unit 101 to the status of displaying the marker image 105 (the video image for capturing) on the display unit 101. For example, while displaying the normal viewing video image, the marker image 105 for capturing is displayed only during a predetermined display period (e.g., 1/30 seconds) in a predetermined display interval (e.g., one second). When starting to alternately display the marker image 105 and the viewing video image, at step S403, the personal computer 102 transmits the display completion signal of the marker image 105 to the digital camera 100.

The marker image 105 comprises marker characters which are displayed in order, for example, 01, 02, 03, - - - , in ascending order from the upper-left side of the display unit 101 as shown in FIG. 1. Each marker character is arranged and associated with a coordinate of the display unit 101. For example, the center of the marker character “01” indicates the coordinate (20, 20) of the display unit 101 and that of the marker character, “02” indicates the coordinate (40, 20). In this way, the marker image 105 comprising the marker characters that are arranged in order, is displayed on the display unit 101, and the personal computer 102 can detect a coordinate of the display unit 101 by using a position of the marker character.

As previously mentioned using the flowchart of FIG. 3, the digital camera 100 captures the display unit 101 that displays the marker image 105 and then the captured image is transmitted to the personal computer 102. For the transmission of this captured image, as shown in FIG. 1, the data signal connection 103 using a wired cable connection such as USB or RS-232C, or wireless communication such as Wireless LAN is utilized. The personal computer 102 receives the image captured by the digital camera 100 via the above mentioned transmission. When the personal computer 102 receives the image captured from the digital camera 100, the control proceeds from step S404 to step S405.

At steps S405 and S406, the personal computer 102 detects which region on the display unit 101 is captured by using a marker image included in the received image. First, the personal computer 102 extracts the marker image from the received image. Second, the personal computer 102 detects which region on the display unit 101 is captured using the marker image. There are various methods for determining a region on the display unit 101 using the captured marker image. For example, as previously mentioned, if the marker images comprises numbers or characters such as 01, 02, - - - , and their displayed position (coordinates) on the display unit 101 are known, then the coordinate of the marker image can be determined by specifying the marker image using a well-known character recognition processing. Alternatively, the personal computer 102 can determine the region of the marker image in the captured image by performing a well-known matching process for the marker image displayed in an entire screen of the display unit 101 and the captured image. Further, if for some reason, the captured image is tilted with rotation, it can easily detect the region on the display unit 101 by applying a well-known rotation determination processing and others to the captured image. In this embodiment, at step S405, the personal computer 102 compares (matches) both images and determines the region captured by the camera 100, and at step S406, it can detect the coordinate of the region. If the personal computer 102 successfully detects the coordinate, the control proceeds from step S407 to step S409. On the other hand, if the personal computer 102 fails to detect the coordinate, the control proceeds from step S407 to step S408. In addition, at step S405, if the marker image cannot be extracted (the marker image does not exist in the captured image), the control proceeds to step S408 via step S407 because it equivalently corresponds to the case of the failure of coordinate detection.

If the personal computer 102 fails to detect the coordinate, in other words, if the control proceeds to step S408, the personal computer 102 transmits information of notifying the failure of coordinate detection. Then, the control proceeds to step S404, and the personal computer 102 waits to receive a captured image from the digital camera 100. On the other hand, if the control proceeds to step S409, the personal computer 102 transmits information of notifying the success of coordinate detection to the digital camera 100. Further, at Step S410, the personal computer 102 stops displaying the marker image on the display unit 101. Thus, the personal computer 102 stops alternately displaying the marker image 105 for image capturing and the viewing video image, and then returns to the state of displaying only the viewing video image. In addition, if the personal computer 102 receives the notice of interruption of obtaining the coordinate (step S311) from the digital camera 100, it immediately stops displaying the marker image 105 on the display unit 101 (step S410), and then the flows shown in FIG. 4 are finished.

Based on the control as explained above, by capturing the marker image displayed on the display unit 101, it is possible to detect which region on the display unit 101 is captured by the digital camera 100. Thus, a user, who is also an observer, can designate a desired position on the display unit 101 by capturing the desired position on the display unit 101. Further, if the user captures it by tilting the digital camera 100 with some rotation angle, the user may designate a desired angle because the tilted angle is detected by using a rotation amount of the captured image. Therefore, the personal computer 102 can display a stored image in the digital camera 100 on the display unit 101 with a desired rotation angle by using the detection values (a coordinate and a rotation amount), and can select a desired image among the images being displayed and can direct to move/delete it.

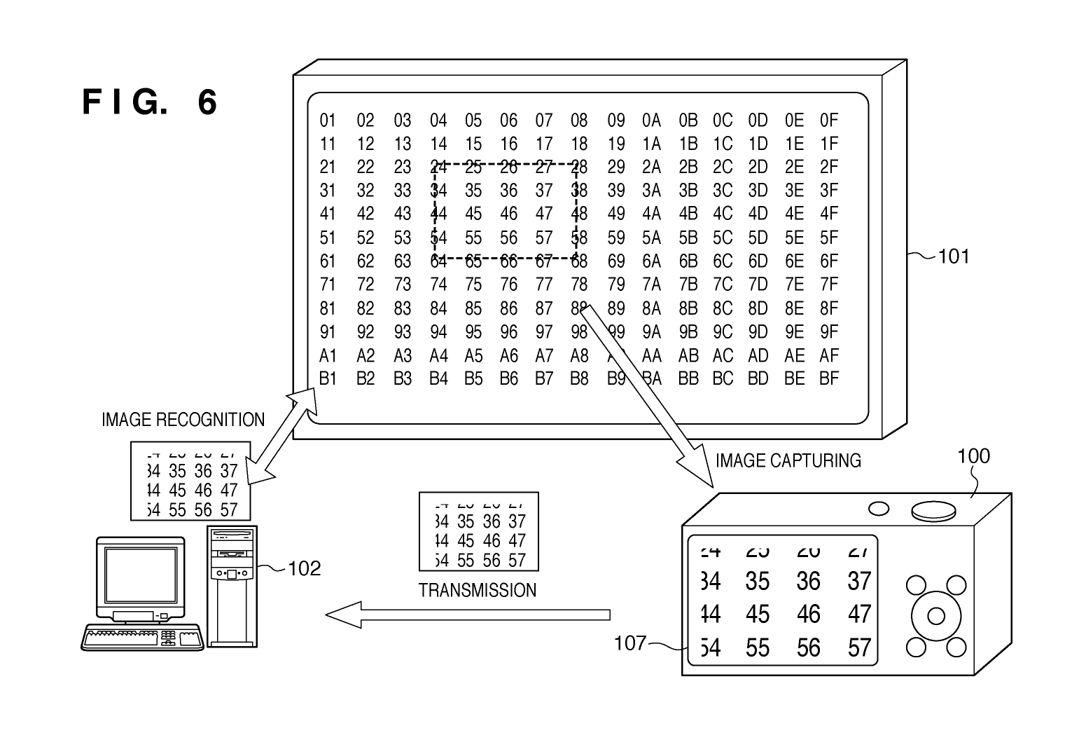

FIG. 6 is an explanatory diagram to explain the step of capturing the marker image 105 to the step of detecting a coordinate on the display unit 101. A photographer captures a desired position on the display unit 101 which displays the marker image 105, referring to the capturing position on the liquid crystal panel 107 of the digital camera 100. As mentioned above, the photographer can easily designate a desired image from the viewing video images displayed because the marker image 105 and the viewing video image are alternately displayed after receiving the capturing preparation signal. The personal computer 102 calculates a coordinate, a captured region and a rotation amount by using image recognition with an image captured by the digital camera 100 and a video image displayed on the display unit 101.

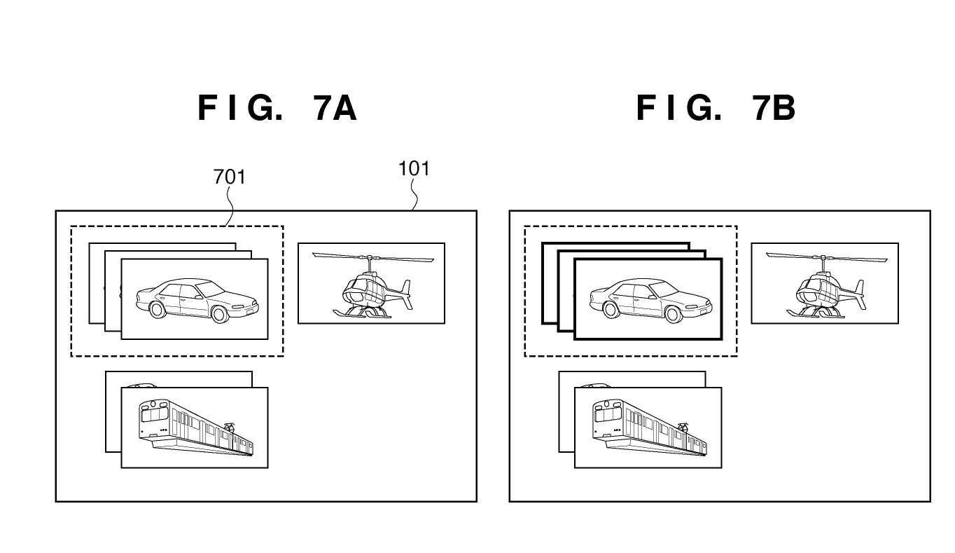

FIGS. 7A and 7B are examples of the display unit 101, to explain the processing for specifically displaying images existing in the calculated coordinate (captured region). As shown in FIG. 7A, a region 701 framed by a dashed line is a captured region which an operator of the digital camera 100 tries to capture by focusing on one region on the display unit 101. If the digital camera 100 captures an image in this condition and transmits the captured image to the personal computer 102, the personal computer 102 then detects a coordinate of the region 701 from a marker image included in the captured image. The personal computer 102 detects images within the detected region 701 (capturing region of the digital camera 100) and specifically displays the detected images. In this embodiment, as shown in FIG. 7B, a specific display of the images is performed by changing normal lines to bolder lines bordering the images. In accordance with the above procedure, the operator can designate (select) a desired image among the images displayed on the display unit 101 by a capturing operation of the digital camera 100.

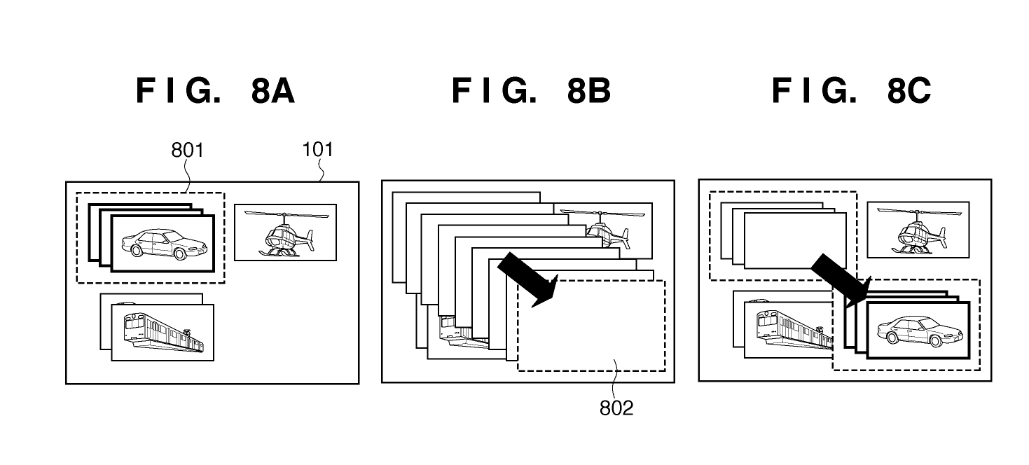

FIGS. 8A to 8C are drawings showing the process of how a displayed position of the selected image is moved. A region 801 framed with a dashed line in FIG. 8A is a captured region which the operator of the digital camera 100 focuses at one region on the display unit 101. If an image is captured by the digital camera 100 in this condition, as mentioned above, images within the region 801 are selected. After this selection, when the captured region of the digital camera 100 is set on a region 802 on the display unit 101 where the image is to move and then is captured, the region 802 for the destination is determined (FIG. 8B). After the destination is determined, as shown in FIG. 8C, the process of moving the image selected by designating the region 801 to the region 802 designated for the destination is performed. In addition, while the operator selects the region 801 and determines the destination, a region frame of the region corresponding to the selected region 801 is displayed on the display unit 101 each single video frame. However, the display frequency of the region frame is not limited to each single video frame but the region frame may be displayed on the display unit 101 at an arbitrary frequency which is more than one video frame in the unit of one frame. Further, when the region 802 for the destination is determined and the selected image is moved, as shown in FIG. 8B, a moving locus of the region frame may be displayed.

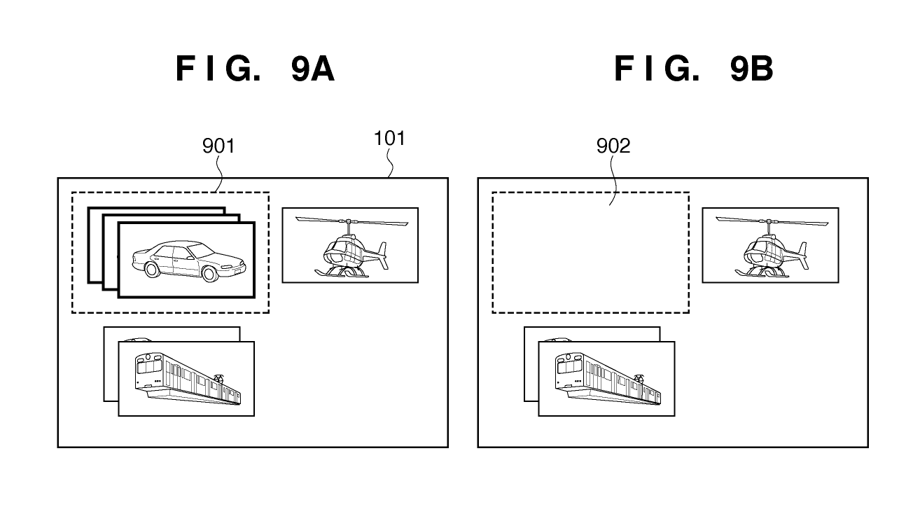

FIGS. 9A and 9B are drawings showing a process of clearing a display of the selected image. A region 901 framed with a dashed line in FIG. 9A corresponds to a selected region where the photographer of the digital camera 100 focuses on one region in the display unit 101. If the digital camera 100 captures an image in this condition, as explained in FIGS. 7A and 7B, then the personal computer 102 recognizes the region 901, and sets images within the region 901 as the selected images. After the selection, if the photographer pushes a clear button on the digital camera 100 which is one of the operational switches 208, then the selected images as shown in FIG. 9B are cleared. In addition, the data for the selected images may also be cleared at the same time. Further, in this case, when the clear button is pushed the digital camera 100 notifies the personal computer 102 that the clear button has been pushed, via the transmission/reception unit 209.

### Second Embodiment As the first embodiment explained with FIGS. 3 and 4, if the digital camera 100 fails in a marker image capturing processing (the personal computer 102 fails to detect a coordinate), then the marker image tries to capture it again. Although a process in accordance with such procedures is simple and a program is also easily generated, for some environments, the marker image capturing processing may not be successful even if the image capture is repeated many times. Therefore, in the second embodiment, if the marker image capturing processing by the digital camera 100 fails, a condition of displaying a marker image is changed to improve a success rate of detecting the marker image when the next capture is performed. In more detail, if detection of a coordinate of the marker image is failed, the success rate that the digital camera 100 captures the marker image is improved by increasing a period of displaying the marker image per unit of time.

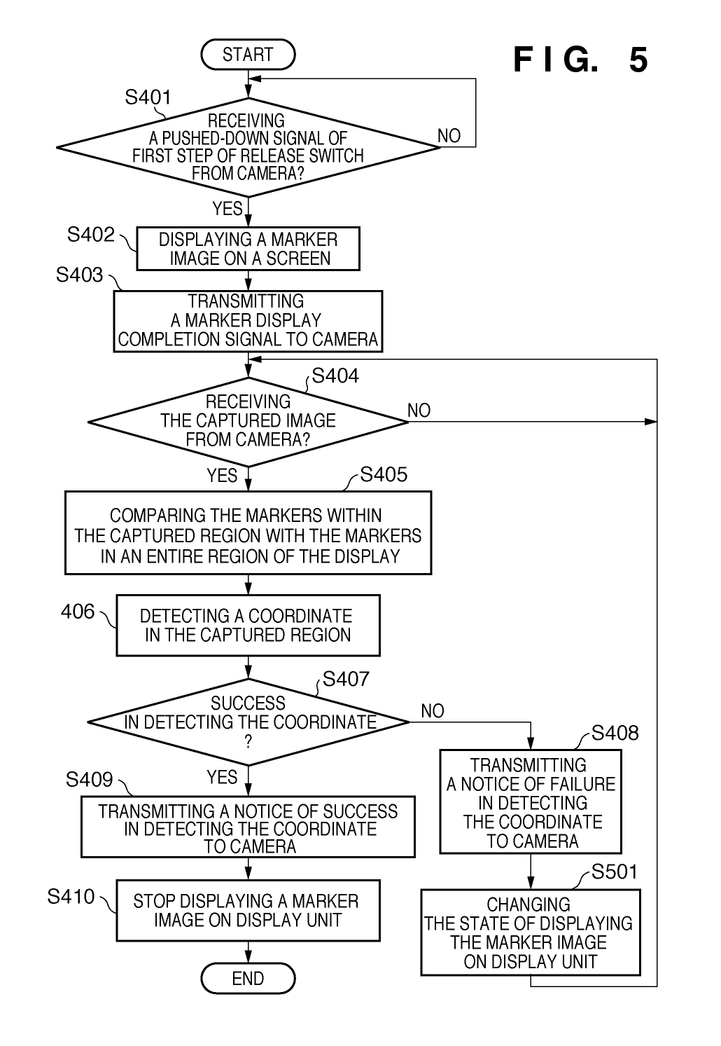

FIG. 5 is a flowchart showing the process of detecting a coordinate by the personal computer 102 in the second embodiment. CPU 251 of the personal computer 102 performs the process of operations as shown in FIG. 5 by extending a program stored in the nonvolatile memory 252 to the memory 253 and implementing it. A process in FIG. 5, which is the same process as in FIG. 4, has the same step number as the step number in FIG. 4. In the second embodiment, at step S408, the personal computer 102 transmits information of notifying the digital camera 100 that the coordinate detection has failed, and then at step S501, a display condition of the marker on the display unit 101 is changed. There are various methods for changing the state of displaying the marker image in order to increase the period of displaying the marker image per unit of time, so some of the methods are explained as follows.

### Change For A Period of Displaying A Marker Image

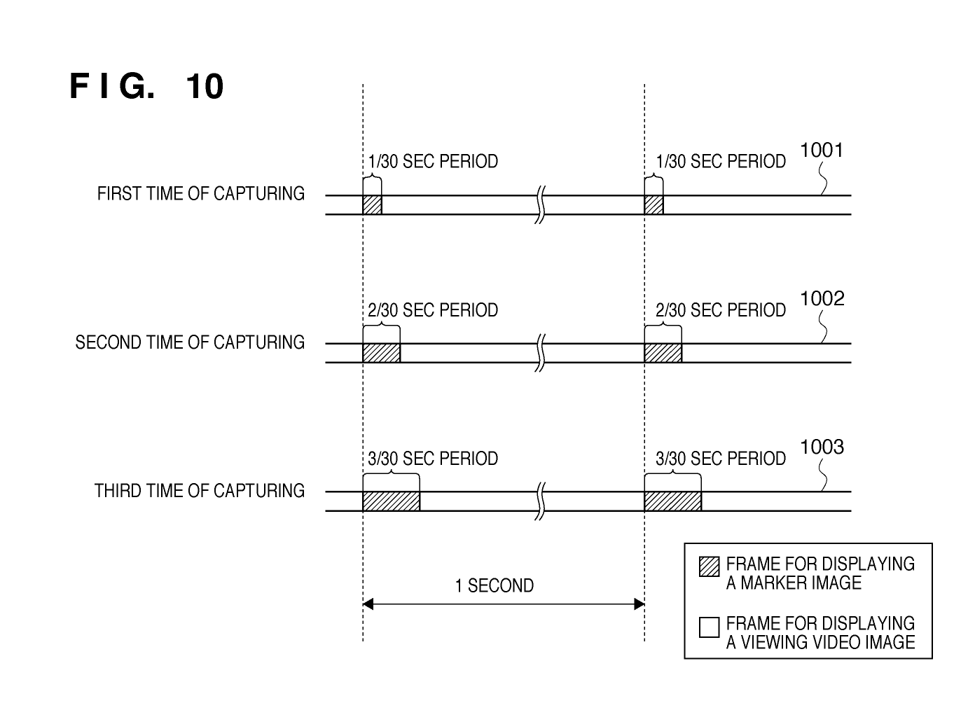

FIG. 10 is a drawing showing the process of extending the period of continuously displaying a marker image on the display unit 101 in this embodiment. In this example, it is assumed that the display unit 101 can display 30 frames per one second. As shown in FIG. 10, at the first time of capturing, the marker image is displayed during 1/30 seconds at a one second interval. The reference numeral “1001” indicates the state of displaying the marker image at the first time of capturing, and displays frames in a time-line on the display unit 101 with the period of continuously displaying is 1/30 seconds and the display interval is one second. If the period of displaying the marker image on the display unit 101 becomes longer, it may be difficult to observe the viewing video image on the display unit 101. Therefore, the period of displaying the marker image is set as short as possible at the first time of capturing.

When detection of the coordinate failed at the first stage of capturing by the digital camera 100, at step S501 in FIG. 5, the condition of displaying the marker is changed. As shown in FIG. 10, by setting the period of displaying the marker image longer, the control is applied to increase the probability of detecting the coordinate at the next time capturing. The reference numeral “1002” indicates the state of displaying the marker image at the second time of capturing, and changes to display frames in a time-line on the display unit 101 when the period of displaying is 2/30 seconds and the display interval is one second.

If the coordinate detection failed even when the period of displaying the marker image is 2/30 seconds, the period of continuously displaying is further extended and changed from 2/30 seconds to 3/30 seconds. The reference numeral “1003” indicates the state of displaying the marker image at the third time of capturing, and changes to display frames in a time-line on the display unit 101 when the period of displaying is 3/30 seconds and the display interval is one second.

If the coordinate detection failed even when the period of displaying the marker image is 3/30 seconds, the control is applied to increase the probability of detecting the coordinate, by setting the period of displaying the marker image longer in the series, such as 4/30 seconds, 5/30 seconds and so on. However, the changed amount of the period of displaying the marker image is not limited to use a constant amount, 1/30 seconds→ 2/30 seconds→ 3/30 seconds, but it may use a different amount, 1/30 seconds→ 2/30 secondsΔ 4/30 seconds, for example.

### Change For A Display Interval of A Marker Image

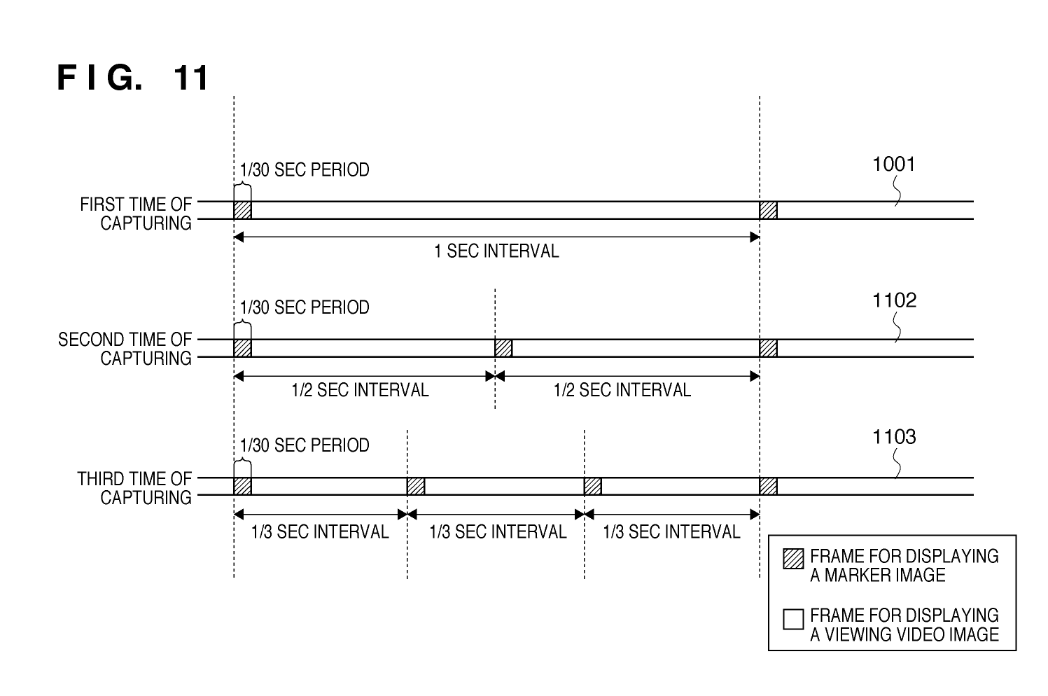

FIG. 11 is a drawing indicating a process of shortening a display interval a marker image on the display unit 101. The reference numeral “1001” indicates the state of displaying the marker image at the first time of capturing, and displays frames in a time-line on the display unit 101 when the period of continuously displaying is 1/30 seconds and the display interval is one second.

If the coordinate detection failed at the first time of capturing, at step S501 in FIG. 5, the state of displaying the marker image on the display unit 101 is changed as shown in FIG. 11. As shown in FIG. 11, the control for improving the probability of detecting a coordinate next time is applied by shortening the display interval of the marker image. The reference numeral “1102” indicates the state of displaying the marker image at the second time of capturing, and changes to display frames in a time-line on the display unit 101 when the period of displaying is 1/30 seconds and the display interval is ½ seconds.

If the coordinate detection failed when the display interval of the marker image is ½ seconds, the display interval of the marker image is further shortened from ½ seconds to ⅓ seconds. The reference numeral “1103” indicates the state of displaying the marker image at the third time of capturing, and changes to display frames in a time-line on the display unit 101 shown when the period of displaying is 1/30 seconds and the display interval is ⅓ seconds. If the coordinate detection failed even when the interval of detecting the marker image is shortened to ⅓ seconds, the control is applied to the personal computer 102 to improve the probability of detecting a coordinate by further shortening the interval to ¼ seconds, ⅕ seconds and so on.

### Change For The Period And Display Interval of A Marker Image

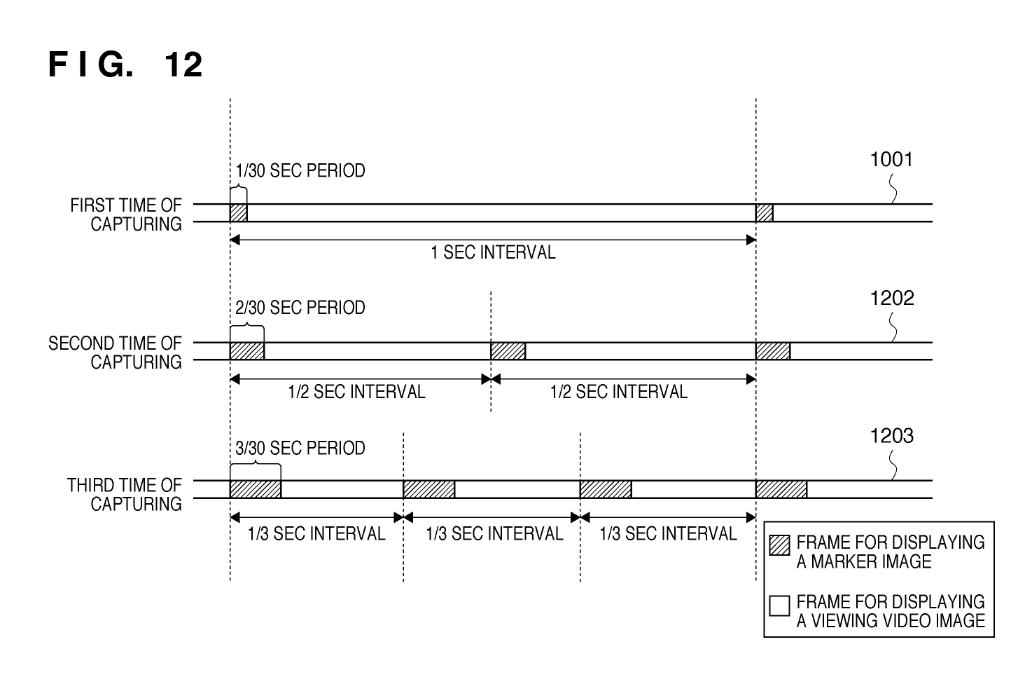

FIG. 12 is a drawing for indicating a process of increasing a period of a marker image and shortening the interval of display of it on the display unit 101. The reference numeral “1001” indicates the state of displaying the marker image at the first time of capturing, and displays frames in a time-line on the display unit 101 when the period of displaying is 1/30 seconds and the display interval is one second.

If the coordinate detection failed at the first time of capturing, at step S501 in FIG. 5, the state of displaying the marker image on the display unit 101 is changed. As shown in FIG. 12, the control for improving the probability of detecting a coordinate next time is applied by changing both the period and the display interval of the marker image. The reference numeral “1202” indicates the state of displaying the marker image at the second time of capturing, and displays frames in a time-line on the display unit 101 when the period of displaying is 2/30 seconds and the display interval is ½ seconds.

If the coordinate detection failed even after change of the period and the display interval of the marker image (the mark “1202”), then the period of displaying the marker image is changed from 2/30 seconds to 3/30 seconds and the interval is changed from ½ seconds to ⅓ seconds as shown with the reference numeral “1203”. In this way, the probability of detecting the coordinate during capture is improved by extending the period of the marker image 105 per unit of time, as needed.

As previously mentioned, in the above embodiments, it is possible to reduce a sense of discomfort given to a user who tries to view a video image. Because the marker image that is an object of detecting a coordinate begins to display after the reception of the capturing preparation signal from the image sensing apparatus. Further, according to this embodiment, a load in the image sensing apparatus is relatively small because the coordinate is calculated in the display control unit. The image sensing apparatus does not need a special function because the image sensing apparatus only needs functions to transmit a signal indicating the ON status of the first stage of the release switch and the captured image to the display control unit.

In addition, although the marker image and the viewing video image are alternately displayed in the above-described embodiments of the invention, it is possible to configure the image sensing apparatus to display only the marker image corresponding to the reception of the capturing preparation signal. In this case, even if the image marker is surely captured, the viewing video image cannot be observed when the first step of the release switch 106 is ON.

Further, this invention can be applied to the configuration described in Ref. 2, such that a coordinate is detected by the digital camera 100. In this case, the system control circuit 207 of the digital camera 100 starts to capture an image at step S306, and then acquires the coordinate indicating a designated position based on the captured image. The digital camera 100 notifies the success or failure of acquiring the coordinate to the personal computer 102. If the personal computer 102 receives the signal indicating the success of acquiring the coordinate from the digital camera 100, then it stops displaying the marker image which was started corresponding to the capture preparation signal.

### Third Embodiment

In the first and second embodiments, the configurations are enabled to designate a desired position (or a desired region) by using the digital camera 100. However, this invention is not limited to apply to only these configurations. For example, the configuration of changing a video image correspondent to a certain purpose of processing from the viewing video image can be applied to some other video images including code images such as a bar code or a QR code. In this case, a viewing video image is displayed when the image is captured with a normal camera operation using a mobile phone as an image sensing apparatus with functions of a camera and code readout. Also, a video image for capturing including a QR code and others can be displayed only when a code readout is performed. However, the mobile phone is assumed to have a function to output a signal indicating on-operation of the function of the code readout. The signal indicating on-operation of the function of code readout is included as a part of the capturing preparation signal in the present invention. The personal computer 102 starts to display a code image such as a QR code, for example, corresponding to the reception of the signal indicating on-operation of the function of the code readout.

Further, it is possible to configure the structure so as not to display unnecessary information for capturing. For example, it is configured such that the QR code is always displayed and the QR code is not displayed only when the image is captured using the camera function (not the code readout function).

As described above, the embodiments in the invention is explained in detail. However, this invention should not be limited to the above embodiments, and various modifications are applicable based on the technical philosophy of this invention.

For example, even though operations related to one image sensing apparatus are introduced in the embodiments, it may be possible to connect the personal computer 102 with a plurality of image sensing apparatus. In this case, each image sensing apparatus captures the screen of the display unit 101 at the same time, the coordinate of the captures regions can be acquired, and moreover, each image sensing apparatus can operate the video image on the display unit 101.

Although the various processes such as selection of the captured images, movement of the selected image and clearance of the selected image are explained as examples in the first and second embodiments, considering that this is the major point of the invention, it is obvious that this invention is not limited to these processes. For example, it is possible to process operations such as enlargement/reduction, duplication, rotation, and replacement of captured images.

Further, although the coordinate is detected by using an entire region of the image captured by the digital camera 100 in the first and second embodiments, the coordinate may be detected by using a part of the captured image. For example, the coordinate may be detected by using an image region within a focus frame in the digital camera 100.

In addition, the control through the system control circuit 207 may be performed by using a single hardware, or the control for the entire apparatus may be performed by a plurality of hardware sharing the processes.

Further, while the present invention has been described with reference to exemplary embodiments, it is important to understand that the invention is not limited to the exemplary embodiments, various embodiments within the scope of the substance of the invention is included in the invention. Further, each embodiment has been explained above is only an exemplary embodiment, and it is possible to appropriately combine these embodiments.

Moreover, although in the embodiments described above, the invention has been explained when it is applied to a digital camera, the invention should not be limited to these embodiments. Thus, the present invention can be applied to devices such as a personal computer, a PDA, a mobile phone, a music player, a game machine and an electronic book reader, which all have a function of capturing an image as an image sensing apparatus.

According to the present invention, it enables to insert an image being an object in analysis of a captured image at an appropriate timing, and to reduce a sense of discomfort given to a user who observes a screen.

### Other Embodiments

Aspects of the present invention can also be realized by a computer through a system or an apparatus (or devices such as a CPU or MPU) that reads out and executes a program recorded on a memory device to perform the functions of the above-described embodiment(s), and the steps of which are performed by a computer of a system or apparatus by a method, for example, reading out and executing a program recorded on a memory device to perform the functions of the above-described embodiment(s). For this purpose, the program is provided to the computer via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded by the broadest interpretation so as to encompass all such modifications and equivalent structures and functions.

This application claims the benefit of Japanese Patent Application No. 2010-048256, filed Mar. 4, 2010, which is hereby incorporated by reference herein in its entirety.

What is claimed is:

1. A display control apparatus for displaying an image on a display screen of a display unit, comprising:
the display unit configured to display a video image on the display screen which a user observes;
a communication unit configured to communicate with an image sensing apparatus, to which communicably connected; and
a control unit configured to switch the image displayed on the display screen from the video image to an image for capturing, prepared by the image sensing apparatus, in response to a reception of a capturing preparation signal form the image sensing apparatus via said communication unit.

2. The display control apparatus according to claim 1, wherein
the image for capturing is a marker image arranged with a plurality of markers, and the control unit alternately displays the marker image and the video image on display screen corresponding to the reception of the capturing preparation signal.

3. The display control apparatus according to claim 2, further comprising:
an acquisition unit configured to acquire a captured image by the image sensing apparatus via said communication unit; and
a detection unit configured to detect a position of the captured image on the display screen based on the marker images included in the captured image, wherein
said control unit stops displaying the marker image by the control unit if said detection unit succeeds in detecting the position of the captured image.

4. The display control apparatus according to claim 3, wherein
said control unit increases a display period of the marker image per a unit of time while alternately displaying the video image and the marker image if said detection unit fails in detecting the position of the captured image.

5. The display control apparatus according to claim 4, wherein
said control unit extends the period of continuously displaying the marker image while alternately displaying the video image and the marker image when extending the display period of the marker image per a unit of time.

6. The display control apparatus according to claim 4, wherein
said control unit shortens a display interval of the marker image while alternately displaying the video image and the marker image when increasing the display period of the marker image per a unit of time.

7. The display control apparatus according to claim 4, wherein
said control unit extends the period of continuously displaying the marker image and shortens a display interval of it while alternately displaying the video image and the marker image when increasing the display period of the marker image per a unit of time.

8. The display control apparatus according to claim 1, wherein
said control unit displays an image as the image for capturing including a code image whose information can be readout by a computer, on the display screen, corresponding to the reception of the capturing preparation signal.

9. A method for controlling a display control unit which displays an image on a display screen of a display unit, comprising steps of:
displaying a video image on the display screen which a user observes; and
switching the image displayed on the display screen from the video image to an image for capturing, prepared by the image sensing apparatus, corresponding to a reception of a capturing preparation signal from the image sensing apparatus via said communication unit.

10. A computer readable non-transitory storage medium in which a computer program that causes a computer to execute the method according to claim 9 is stored.
